(19) United States
(12) Patent Application Publication
(10) Pub. No.: US 2026/0192498 A1
(43) Pub. Date: Jul. 9, 2026

(54) MANUFACTURING DEVICE FOR VEHICLE CRASH PAD AND VEHICLE CRASH PAD MANUFACTURED USING THE SAME

(71) Applicants: Hyundai Motor Company, Seoul (KR); Kia Corporation, Seoul (KR); Seoyon Autovision Co., Ltd., Dangjin-si (KR); Hyundai Mobis Co., Ltd., Seoul (KR)

(72) Inventors: Jae Hyun AN, Hwaseong-si (KR); Won Young BAE, Hwaseong-si (KR); In Soo HAN, Hwaseong-si (KR); Chang Hoon YANG, Hwaseong-si (KR); Young In YOU, Asan-si (KR); Young Jae YOU, Gunpo-si (KR); Kwon Jun HWANG, Gunpo-si (KR); Dong Eun LEE, Anyang-si (KR); Jae Seob CHOI, Yongin-si (KR); Ik Keun CHOI, Yongin-si (KR); Young Jin YOU, Yongin-si (KR)

(21) Appl. No.: 19/261,856

(22) Filed: Jul. 7, 2025

(30) Foreign Application Priority Data
Jan. 9, 2025 (KR) 10-2025-0003155

(51) Int. Cl. B29C 45/26; B29C 45/14; B29C 45/33; B29L 31/30; B60R 21/04

(52) U.S. Cl. CPC B29C 45/2602; B29C 45/14008; B29C 45/14073; B29C 45/332; B60R 21/04; B29C 2045/336; B29L 2031/3038

(57) ABSTRACT

A manufacturing device for a vehicle crash pad includes a scrim fixing module configured to fix bent ends of an insert scrim, a first mold including a fixing module mounting portion and a cam block, the fixing module mounting portion configured to movably support the scrim fixing module, and the cam block being configured to operate the scrim fixing module, a mold plate including a first actuator and a second actuator, the first actuator being configured to operate the cam block, and the second actuator being configured to operate the first mold, and a second mold configured to join with the first mold. The first and second molds are configured to define, through combination thereof, a cavity between the first mold and the second mold to be filled with a molding resin for the vehicle crash pad.

### CROSS-REFERENCE TO RELATED APPLICATION

This application claims, under 35 U.S.C. § 119(a), the benefit of priority from Korean Patent Application No. 10-2025-0003155, filed on Jan. 9, 2025, the entire contents of which are incorporated herein by reference.

### TECHNICAL FIELD

The present disclosure relates to a manufacturing device for a vehicle crash pad and the vehicle crash pad manufactured using the same, more particularly to, a manufacturing device for a vehicle crash pad formed to be integrated with an airbag door portion and the vehicle crash pad manufactured using the same.

### BACKGROUND

A crash pad in a vehicle may refer to a plastic panel mounted on a lower portion of a windshield of the vehicle. For instance, the crash pad may be provided with a steering wheel, a dashboard, and an airbag.

The airbag mounted in the crash pad is provided for a passenger sitting on the front passenger seat and is also referred to as a passenger airbag (PAB). The passenger airbag is one of the components included in a vehicle cockpit module and is disposed in the front space of the crash pad.

The passenger airbag may be covered by an airbag door of the crash pad so as not to be exposed to the outside. In the event of vehicle collision, the airbag door may be opened by inflation of the passenger airbag, where the passenger airbag is deployed to the outside of the crash pad so as to protect the passenger.

In some cases, the crash pad may be manufactured through a method in which a crash pad upper panel and an airbag chute are separately prepared through injection molding, and then the crash pad upper panel and the airbag chute are bonded to each other through vibration fusion.

In some cases, the airbag chute may be manufactured through insert injection molding using a manufacturing mold for an airbag chute. When the airbag chute is manufactured, a flat scrim serving as an insert member is first inserted into the manufacturing mold for an airbag chute, and an airbag chute resin is injected into the mold. The airbag chute may include an airbag door and an airbag chute body provided with the airbag door.

In some cases, the crash pad may be manufactured through a separate molding process and a fusion process for the crash pad upper panel and the airbag chute, leading to an increase in manufacturing time and manufacturing cost.

### SUMMARY

The present disclosure describes a manufacturing device for a vehicle crash pad and the vehicle crash pad manufactured using the same, where the manufacturing device is configured to mold the vehicle crash pad including an insert scrim in a single molding device.

According to one aspect of the subject matter described in this application, a manufacturing device for a vehicle crash pad includes a scrim fixing module configured to hold opposite bent ends of an insert scrim of the vehicle crash pad. The manufacturing device further includes a first mold including a fixing module mounting portion that accommodates the scrim fixing module therein, and a cam block disposed in the first mold and configured to operate the scrim fixing module. The manufacturing device further includes a mold plate including a first actuator figured to operate the cam block, and a second actuator configured to operate the first mold. The manufacturing device further includes a second mold configured to join with the first mold and to define a cavity between the first mold and the second mold based on joining with the first mold, where the cavity is configured to receive a molding resin for the vehicle crash pad.

Implementations according to this aspect can include one or more of the following features. For example, the cavity can be configured to accommodate the insert scrim seated on the scrim fixing module. In some examples, the first mold can further include a cam block mounting portion located adjacent to and fluidly connected with the fixing module mounting portion, where the cam block is disposed at the cam block mounting portion and configured to linearly move relative to the cam block mounting portion along a movement direction, and the fixing module mounting portion extends obliquely relative to the movement direction of the cam block.

In some examples, the cam block mounting portion can include a pair of support blocks, and the cam block is slidably disposed between the pair of support blocks. In some examples, the scrim fixing module can include a base block having a lower portion supported by the pair of support blocks, a center core coupled to an inner side of the base block and configured to linearly move in the base block, the center core being connected to the cam block and configured to linearly move in the base block based on a linear movement of the cam block, a pair of scrim fixing blocks disposed at an upper portion of the base block, each of the pair of scrim fixing blocks being configured to move to an outer side of the base block and to return to the inner side of the base block based on a linear movement of the center core, and a seating block having (i) an upper surface configured to support the insert scrim thereon and (ii) a lower surface disposed on the pair of scrim fixing blocks.

In some examples, the center core can include a first core rail and a second core rail that are disposed at an upper portion of the center core, where the pair of scrim fixing blocks are configured to slidably move along the first core rail and the second core rail. In some examples, the first core rail and the second core rail extend obliquely relative to a movement direction of the center core, where a first end of the first core rail and a first end of the second core rail extend toward each other.

In some implementations, the pair of scrim fixing blocks can include a first scrim fixing block including a first linkage portion configured to slidably move along the first core rail, and a first holding portion formed to be integrated with the first linkage portion, where the first holding portion is configured to, based on the first linkage portion moving to the first end of the first core rail, hold a first end of the insert scrim stacked on the seating block. In some examples, the pair of scrim fixing blocks can include a second scrim fixing block including a second linkage portion configured to slidably move along the second core rail, and a second holding portion that extends from the second linkage portion and is configured to, based on the second linkage portion moving to the first end of the second core rail, hold a second end of the insert scrim disposed at the seating block.

In some implementations, the cam block can include a cam rail that is obliquely disposed at an upper portion of the cam block, where the center core can include a core rib that is disposed at a lower portion of the center core and configured to slidably move along the cam rail. In some examples, the base block can include a base rib disposed at a lower portion of the base block, where the pair of support blocks include a support rail that is disposed at an upper portion thereof and configured to guide the base rib to slidably move along the support rail.

In some implementations, the first actuator can be configured to maintain the cam block at a position while the first mold moves in a first direction away from the mold plate, and to linearly move the cam block away from the mold plate based on completion of a movement of the first mold in the first direction. In some examples, the pair of scrim fixing blocks can be configured to move toward the outer side of the base block based on the cam block moving away from the mold plate by the first actuator, where the seating block and each of the pair of scrim fixing blocks are configured to define a gap between a side surface of the seating block and a side surface of one of the pair of scrim fixing blocks, each of the gaps being configured to receive one of opposite ends of the insert scrim.

In some implementations, the first actuator can be configured to move the cam block toward the mold plate based on the opposite ends of the insert scrim being inserted into the gaps, respectively, where the pair of scrim fixing blocks are configured to press the opposite ends of the insert scrim toward side surfaces of the seating block.

In some implementations, the manufacturing device further includes a preforming device configured to, before the insert scrim is provided to the scrim fixing module, form the insert scrim into a plate-shaped structure having the opposite ends that are bent. For instance, the preforming device can include a jig configured to support a scrim material having a flat plate structure, a center pressing plate configured to move toward an upper surface of the jig and to press the scrim material on the upper surface of the jig to restrict the scrim material from moving, a pair of corner pressing plates configured to move toward opposite corner portions of the jig and to bend the opposite ends of the scrim material on the jig, and a pair of side pressing plates configured to press the opposite ends of the scrim material that are respectively bent toward opposite side surfaces of the jig, the pair of side pressing plates being configured to bring the opposite ends of the scrim material into contact with the opposite side surfaces of the jig.

In some examples, the opposite side surfaces of the jig can be tapered toward each other. In some examples, the jig can include protrusions that are respectively disposed at the opposite corner portions of the jig, each of the protrusions protruding toward one of the pair of corner pressing plates.

According to another aspect, a vehicle crash pad includes a crash pad upper panel including an airbag door portion, and an insert scrim attached to the airbag door portion. The insert scrim includes a center scrim portion attached to a lower surface of the airbag door portion, and a pair of side scrim portions that are respectively bent downward from opposite edges of the center scrim portion.

Implementations according to this aspect can include one or more of the following features. For example, the crash pad upper panel can further include a plurality of reinforcing ribs that are respectively located adjacent to edges of the airbag door portion, the plurality of reinforcing ribs protruding downward from a lower surface of the crash pad upper panel, and each of the pair of side scrim portions is coupled to one of the plurality of reinforcing ribs.

In the present application, the terms “vehicle”, “vehicular”, and other similar terms are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

### BRIEF DESCRIPTION OF THE DRAWINGS

The above and other features of the present disclosure will now be described in detail with reference to one or more implementations thereof illustrated in the accompanying drawings which are given hereinbelow by way of illustration only, and thus are not limitative of the present disclosure.

FIG. 1 is a perspective view illustrating an example of a molding device included in a crash pad manufacturing device.

FIG. 2 is a view showing a cross-sectional structure of the molding device.

FIGS. 3 and 4 are views each showing a partial configuration of an example of a scrim fixing module included in the molding device.

FIGS. 5 to 11 are views each showing an example operating state of the molding device.

FIG. 12 is a perspective view illustrating an example of an insert scrim.

FIG. 13 is a perspective view illustrating an example of a vehicle crash pad.

FIG. 14 is a cross-sectional view taken along line A-A in FIG. 13;

FIG. 15 is a view showing an example of a preforming device included in the crash pad manufacturing device. and

FIG. 16 is a view showing an example operating state of the preforming device.

In the figures, reference numbers refer to the same or equivalent parts of the present disclosure throughout the several figures of the drawing.

### DETAILED DESCRIPTION

Hereinafter, reference will be made in detail to various implementations of the present disclosure, examples of which are illustrated in the accompanying drawings and described below. Further, the matters represented in the accompanying drawings are schematically illustrated in order to easily explain the implementations of the present disclosure, and can be different from actually implemented forms.

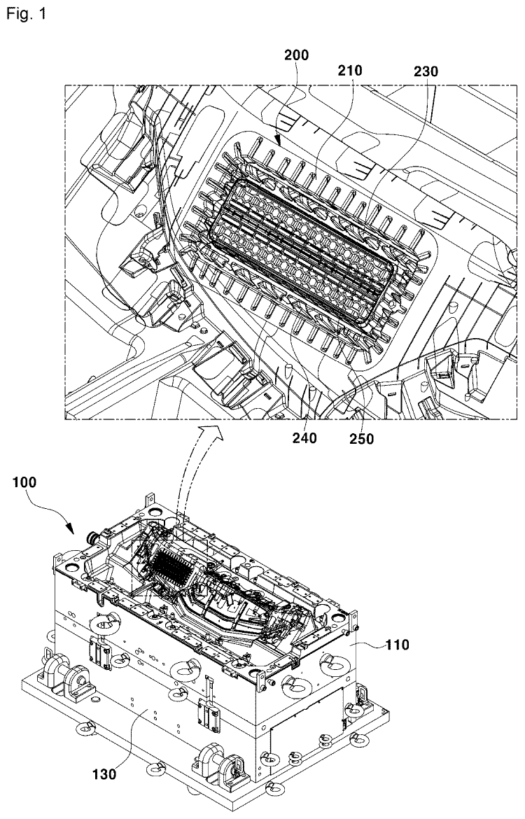

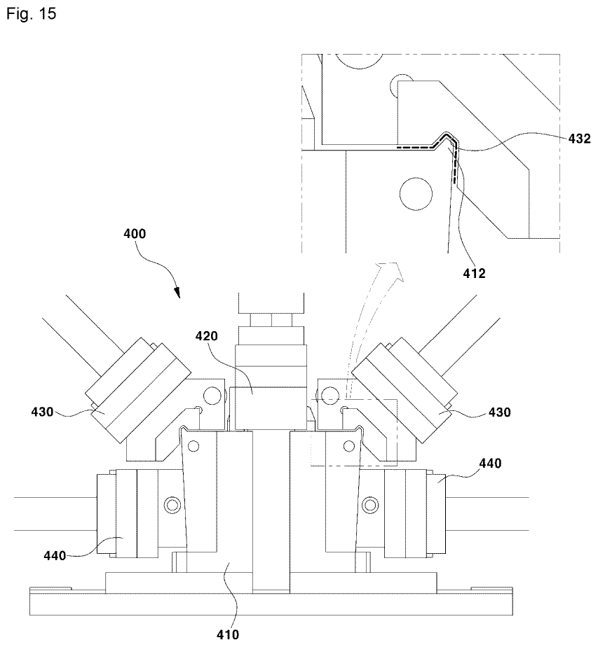

In some implementations, a manufacturing device for a vehicle crash pad is configured to manufacture the vehicle crash pad by an insert injection molding method. The manufacturing device includes a molding device 100 shown in FIGS. 1 to 4 and a preforming device 400 shown in FIG. 15.

The molding device 100 is configured to include a scrim fixing module 200 configured to hold and fix an insert scrim 320, a first mold 110 including the scrim fixing module 200, and a second mold 120 combined with the first mold 110.

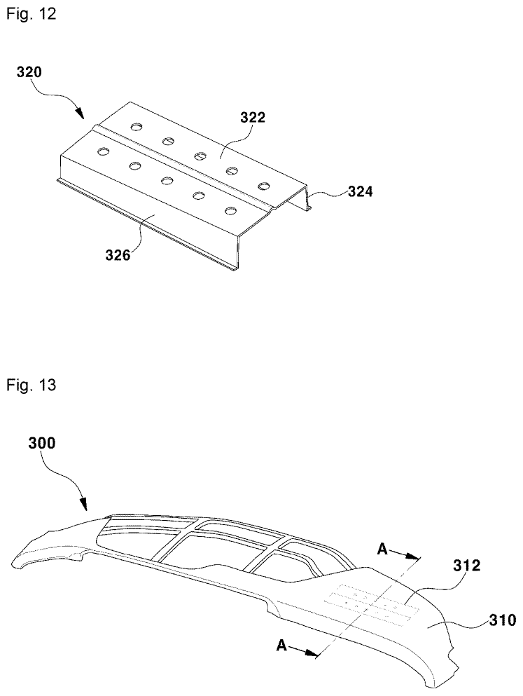

In some examples, the insert scrim 320 (see FIG. 12) can be pre-formed into a plate-shaped structure having opposite ends bent in the same direction through the preforming device 400. That is, the preforming device can be configured to, before the insert scrim is provided to the scrim fixing module, form the insert scrim 320 into the plate-shaped structure having the opposite ends that are bent. The insert scrim 320 includes a center scrim portion 322 and a pair of side scrim portions 324 and 326 respectively bent from the opposite edges of the center scrim portion 322.

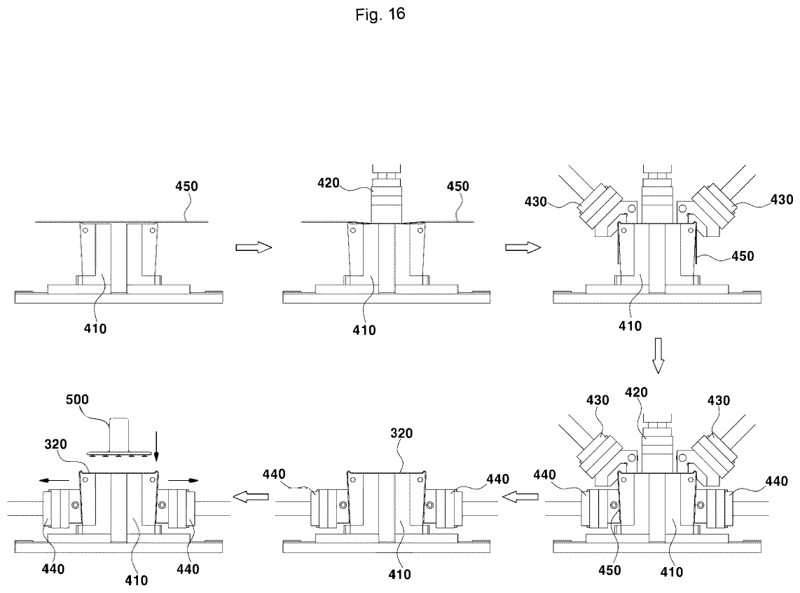

When the insert scrim 320 is completely preformed using the preforming device 400, the insert scrim 320 is picked up by a robot 500 which is a type of automated equipment (refer to FIG. 16). The robot 500 transfers the insert scrim 320 picked up from the preforming device 400 to the molding device 100.

The insert scrim 320 is positioned and fixed in a space (for example, a cavity) to be filled with a molding resin in the molding device 100 through the scrim fixing module 200. A cavity C is formed and sealed between the first mold 110 and the second mold 120 when the first mold 110 is combined with the second mold 120. The molding resin is used to mold a crash pad. In some examples, the molding device 100 includes a plurality of resin injection ports through which the molding resin is injected, and the resin injection ports communicate with the cavity C.

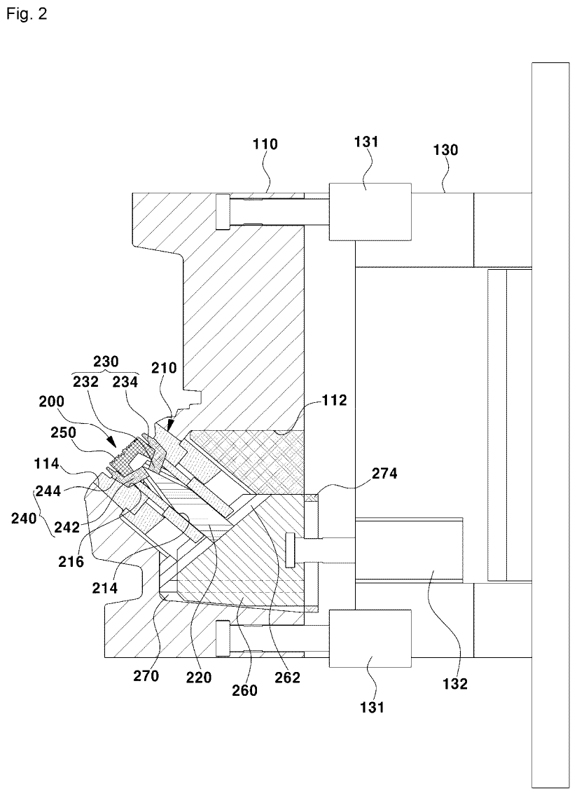

As shown in FIG. 2, the scrim fixing module 200 is configured to include a base block 210, a center core 220, a pair of scrim fixing blocks 230 and 240, and a seating block 250.

The base block 210 has an inner space (for example, a chamber) into which the center core 220 is slidably inserted. The chamber 214 is disposed below the seating block 250. The base block 210 has an open upper side and an open lower side for linear movement of the center core 220 inserted into the chamber 214.

A step portion 216 is provided on the upper side of the base block 210 so as to stack and support the scrim fixing blocks 230 and 240.

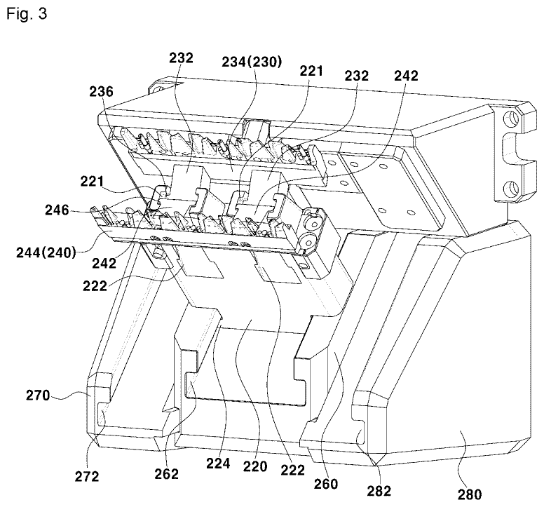

Referring to FIGS. 2 and 3, the pair of scrim fixing blocks 230 and 240 is stacked and fixed on the step portion 216. In some examples, the scrim fixing blocks are arranged to face each other. Each of the scrim fixing blocks 230 and 240 has a lower portion (that is, a linkage portion) connected to the upper portion of the center core 220. The upper portion of the center core 220 is provided with a pair of core rails 221 and 222 in two rows, and linkage portions 232 and 242 of the scrim fixing blocks 230 and 240 are provided with linkage ribs 236 and 246 respectively inserted into and assembled with the core rails 221 and 222.

The upper portions (that is, holding portions) of the scrim fixing blocks 230 and 240 are formed to be integrated with the linkage portions 232 and 242. Holding portions 234 and 244 and the linkage portions 232 and 242 are formed to have an approximately L-shaped curved structure.

In the pair of scrim fixing blocks 230 and 240, a linkage rib (that is, a first linkage rib) of the first scrim fixing block 230 is slidably assembled with the first core rail 221, and a linkage rib (that is, a second linkage rib) of the second scrim fixing block 240 is slidably assembled with the second core rail 222. The first linkage rib 236 is formed at the end of the first linkage portion 232, and the second linkage rib 246 is formed at the end of the second linkage portion 242.

Each of the first core rail 221 and the second core rail 222 obliquely extends at a predetermined inclination relative to the movement direction of the center core 220 and is provided on the side surface of the center core 220. In this case, a first end of the first core rail 221 and a first end of the second core rail 222 extend in a direction toward each other, and a second end of the first core rail 221 and a second end of the second core rail 222 extend in a direction away from each other so as to be separated from each other.

Accordingly, a distance between the second end of the first core rail 221 and the second end of the second core rail 222 can be set to be larger than a distance between the first end of the first core rail 221 and the first end of the second core rail 222 by a predetermined distance value or more. The first end of the first core rail 221 and the first end of the second core rail 222 can be adjacent to each other at the upper side of the center core 220. The second end of the first core rail 221 and the second end of the second core rail 222 can be spaced apart from each other by a thickness of the center core 220.

The first scrim fixing block 230 and the second scrim fixing block 240 are moved in a direction away from each other or toward each other in conjunction with linear movement of the center core 220. The scrim fixing blocks 230 and 240 are moved to the outside of the base block 210 in conjunction with first direction movement of the center core 220, and are moved to the inside of the base block 210 in conjunction with second direction movement of the center core 220 so as to be returned to the original positions thereof.

In some examples, the first direction movement of the center core 220 can refer to an upward movement toward the outside of the first mold 110. The second direction movement of the center core 220 can refer to a downward movement toward a cam block mounting portion 112 of the first mold 110.

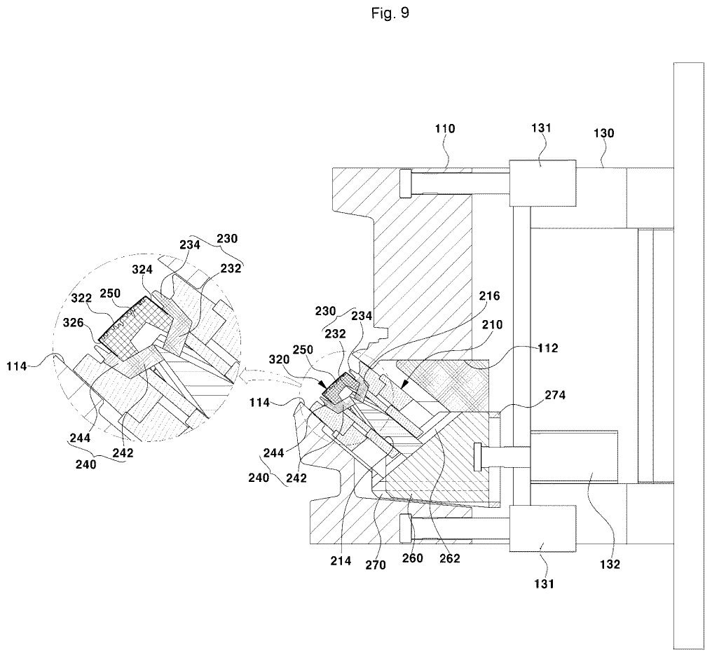

The first scrim fixing block 230 includes the first linkage portion 232 having the first linkage rib 236, and the first holding portion 234 formed to be integrated with the first linkage portion 232. When the first linkage portion 232 is moved to the first end of the first core rail 221, the first holding portion 234 is pressed against a first side surface of the seating block 250 and holds a first end (that is, a first side scrim portion) of both ends of the insert scrim 320 stacked on the seating block 250 (refer to FIG. 9).

The second scrim fixing block 240 includes the second linkage portion 242 having the second linkage rib 246, and the second holding portion 244 formed to be integrated with the second linkage portion 242. When the second linkage portion 242 is moved to the first end of the second core rail 222, the second holding portion 244 is pressed against a second side surface of the seating block 250 and holds a second end (that is, a second side scrim portion) of both ends of the insert scrim 320 (refer to FIG. 9).

The seating block 250 is stacked and seated on the linkage portions 232 and 242 of the scrim fixing blocks 230 and 240. The seating block 250 has an upper surface on which the insert scrim 320 is stacked and disposed. Specifically, the center scrim portion 322 of the insert scrim 320 is stacked on the upper surface of the seating block 250.

In some examples, the upper surface of the seating block 250 can be provided with a plurality of guide pins configured to regulate and determine the stacking position of the insert scrim 320. The guide pins can protrude and extend upwards from the upper surface of the seating block 250 and can prevent movement of the insert scrim 320 disposed on the upper surface of the seating block 250.

The side surfaces of the seating block 250 can be respectively adjacent to the holding portions 234 and 244 of the scrim fixing blocks 230 and 240, and the lower surfaces of the seating block 250 can be respectively stacked on and in contact with the linking portions 232 and 242 of the scrim fixing blocks 230 and 240.

The center core 220 is inserted into the chamber 214 of the base block 210 so as to be linearly movable therein and is moved toward the seating block 250 within the chamber 214 or toward the opposite side of the seating block 250. The center core 220 is connected to a cam block 260 so as to be movable within the chamber 214 by linear movement of the cam block 260.

The center core 220 is moved linearly in conjunction with the operation of the cam block 260. In order to allow the center core 220 to be moved in conjunction with the operation of the cam block 260, the center core 220 has a lower portion that is slidably assembled with the upper portion of the cam block 260. A cam rail 262 is obliquely provided on the upper portion of the cam block 260, and a core rib 224 is provided on the lower portion of the center core 220. The core rib 224 is slidably assembled with the cam rail 262.

The base block 210 has a lower portion supported by a pair of support blocks 270 and 280. In some examples, the support blocks 270 and 280 are arranged in the cam block mounting portion 112 formed in the first mold 110. The cam block 260 is disposed so as to be linearly movable in the cam block mounting portion 112. The cam block 260 is disposed so as to be slidable between the pair of support blocks 270 and 280 in the cam block mounting portion 112. The cam block 260 is assembled with the pair of support blocks 270 and 280 so as to be slidable therebetween.

As shown in FIG. 2, the lower portion of the first mold 110 is supported by a mold plate 130. The first mold 110 is detachably connected to the mold plate 130 by a plurality of first actuators 131. The first mold is moved forwards in a direction away from the mold plate 130 or is moved rearwards in a direction toward the mold plate 130 by the first actuators 131. The first actuator 131 can be operated by a controller configured to perform overall control of the crash pad manufacturing device according to the present disclosure. For example, each of the first actuators 131 can be a hydraulic cylinder. A second actuator 132 to be described later can also be controlled by the controller, and a hydraulic cylinder can be applied to the second actuator.

The first mold 110 includes a fixing module mounting portion 114 configured for the scrim fixing module 200 to be operably inserted thereinto and mounted therein, and the cam block mounting portion 112 configured for the cam block 260 to be linearly movably inserted thereinto and mounted therein.

The cam block mounting portion 112 is a space formed to be recessed in the central portion of the first mold 110 in the movement direction of the first mold 110, and the fixing module mounting portion 114 is a space formed to be obliquely recessed in the central portion of the first mold 110. The cam block mounting portion 112 can be formed to be recessed from the front surface of the first mold 110, and the fixing module mounting portion 114 can be formed to be recessed from the rear surface of the first mold 110. The fixing module mounting portion 114 extends obliquely relative to the movement direction of the first mold 110 and the cam block 260 and is obliquely formed at a predetermined inclination. In addition, the fixing module mounting portion 114 is adjacent to and communicates with the cam block mounting portion 112.

The cam block 260 is moved forwards and rearwards by the second actuator 132 mounted on the mold plate 130. The cam rail 262 extends obliquely at a predetermined inclination relative to the linear movement direction of the cam block 260. When the first mold 110 is moved forwards, the rear end of the cam block 260 protrudes to the outside of the cam block mounting portion 112. The cam rail 262 can extend in a direction approximately perpendicular to the movement direction of the center core 220.

The support blocks 270 and 280 are inserted into and disposed in the cam block mounting portion 112. Each of the support blocks 270 and 280 has a rear end locking portion 274 adjacent to the rear end of the cam block 260. When the first mold 110 is moved forwards, the rear end of each of the support blocks 270 and 280 relatively protrudes outwards from the cam block mounting portion 112.

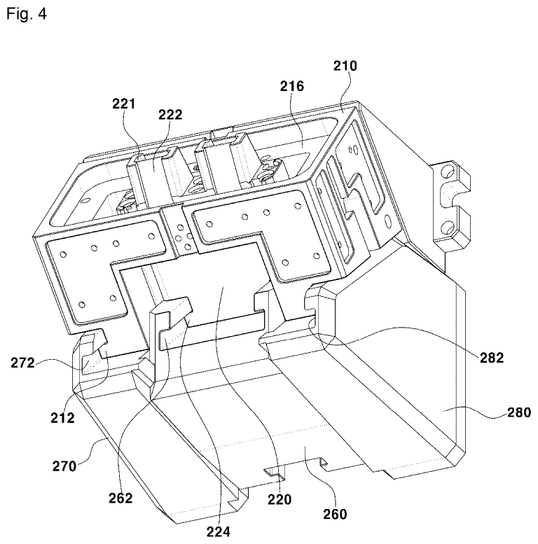

Referring to FIGS. 3 and 4, the support blocks 270 and 280 respectively have support rails 272 and 282 configured to slidably support the lower portion of the base block 210. The support rails 272 and 282 are provided on the respective upper portions of the support blocks 270 and 280. Base ribs 212 are provided on the lower portion of the base block 210. The base ribs 212 are slidably assembled with the support rails 272 and 282, respectively. The support rails 272 and 282 extend to have a predetermined inclination relative to the linear movement direction of the support blocks 270 and 280.

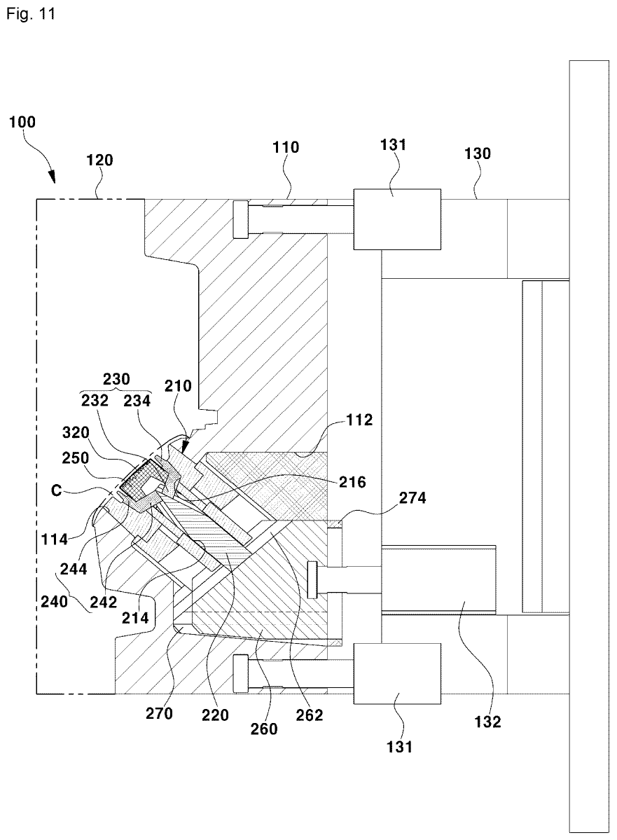

Referring to FIG. 11, when the first mold 110 and the second mold 120 are combined, the cavity C is formed between the first mold 110 and the second mold 120. In some examples, the molding resin for the crash pad fills the cavity C. In some examples, the second mold 120 can be configured to be moved by a third actuator. The second mold 120 can be configured to be moved in a direction to be combined with the first mold 110 or to be moved in a direction to be separated from the first mold 110.

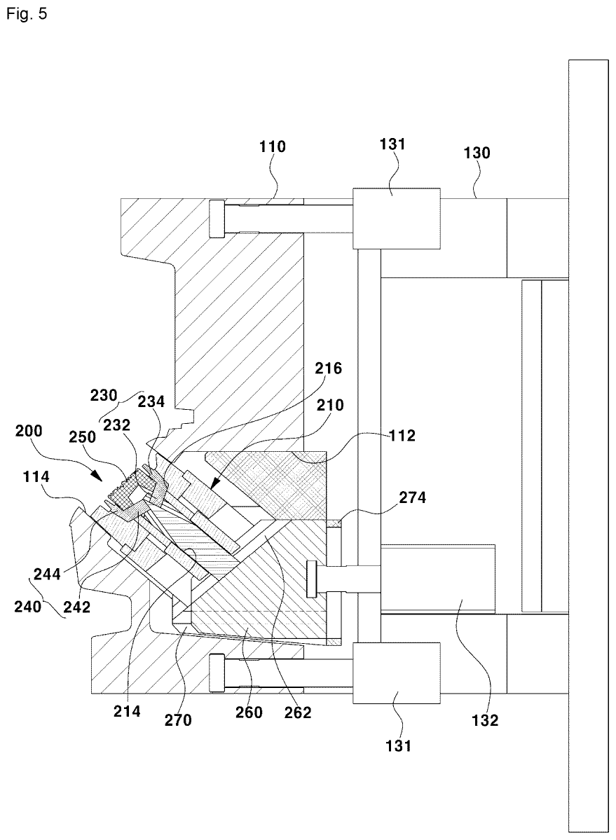

In some examples, the operation process of the molding device 100 will be described with reference to FIGS. 5 to 11.

As shown in FIG. 5, the first mold 110 is moved in a first direction (that is, in a direction toward the opposite side of the mold plate) to be separated from the mold plate 130 by the first actuator 131. In this case, the cam block 260 is in a state of being fixed to the second actuator 132 and as such, the cam block is not moved. The support blocks 270 and 280 maintain the respective original positions thereof with the cam block 260 by the rear end locking portion 274 adjacent to the rear end of the cam block 260.

Accordingly, the rear ends of the cam block 260 and the support blocks 270 and 280 protrude outwards from the cam block mounting portion 112. The scrim fixing module 200, the lower portion of which is supported by the cam block 260 and the support blocks 270 and 280, is also moved to the rearward direction and the downward direction of the fixing module mounting portion 114. In this case, the center core 220 is moved downwards when the core rib 224 is slidably moved along the cam rail 262, and the base block 210 is moved downwards when the base ribs 212 are slidably moved along the support rails 272 and 282, respectively.

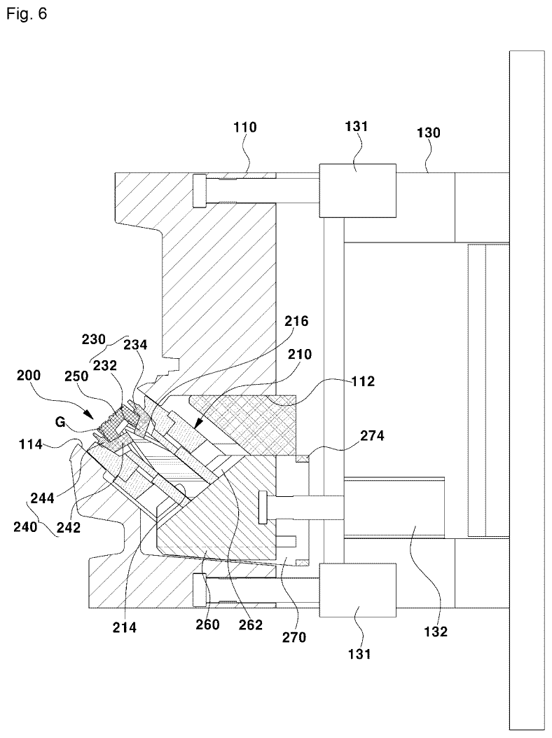

As shown in FIG. 6, when the first direction movement of the first mold 110 is completed, the cam block 260 is moved to the opposite side of the mold plate (that is, the first direction) by the second actuator 132. At this time, the support blocks 270 and 280 are not moved. The support blocks 270 and 280 can be coupled to the mold plate 130.

When first direction movement of the cam block 260 is performed, the center core 220 is moved upwards toward the seating block 250 within the chamber 214 of the base block 210. In some examples, the base block 210 is supported by the support blocks 270 and 280 so as to prevent movement thereof, and the linkage portions 232 and 242 of the scrim fixing blocks 230 and 240 are separated from the step portion 216 of the base block 210.

Accordingly, the first linkage portion 232 and the second linkage portion 242 are respectively moved toward the second ends of the first core rail 221 and the second core rail 222, and then are moved in the direction away from each other while respectively descending along the first core rail 221 and the second core rail 222. That is, the first linkage portion 232 and the second linkage portion 242 are moved toward the outside of the base block 210.

Therefore, the holding portions 234 and 244 of the scrim fixing blocks 230 and 240 are respectively separated from the side surfaces of the seating block 250, and predetermined gaps G are respectively formed between the holding portions 234 and 244 of the scrim fixing blocks 230 and 240 and the side surfaces of the seating blocks 250.

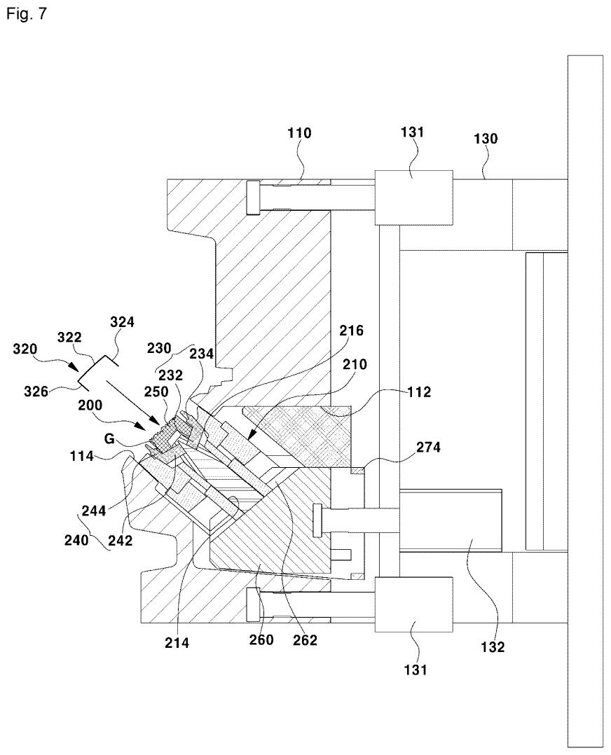

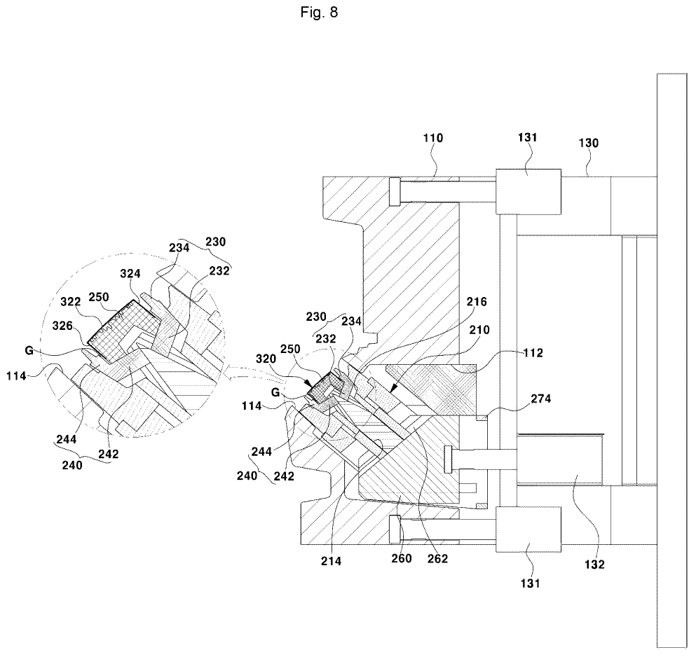

Next, as shown in FIGS. 7 and 8, the insert scrim 320 is inserted into and stacked on the upper surface of the seating block 250. In this case, the center scrim portion 322 of the insert scrim 320 is stacked on the upper surface of the seating block 250, and the side scrim portions 324 and 326 are respectively inserted into the gaps G.

Afterwards, as shown in FIG. 9, the cam block 260 is moved rearwards toward the mold plate 130 by the second actuator 132. In some examples, the cam block 260 is returned to a position at which the rear end of the cam block is adjacent to the rear end locking portion 274 of each of the support blocks 270 and 280.

Accordingly, the core rib 224 of the center core 220 is slidably moved along the cam rail 262 of the cam block 260, and the center core 220 is moved downwards toward the cam block mounting portion 112. In some examples, the base block 210 is supported by the support blocks 270 and 280 so as to prevent movement thereof, and the linkage portions 232 and 242 of the scrim fixing blocks 230 and 240 are seated on the step portion 216 of the base block 210.

In this case, the first linkage portion 232 and the second linkage portion 242 are respectively moved along the core rails 221 and 222 of the center core 220 through the linkage ribs 236 and 246 and are moved in a direction toward each other. As a result, the first holding portion 234 and the second holding portion 244 are respectively moved toward the first side surface and the second side surface of the seating block 250. Therefore, the first holding portion 234 and the second holding portion 244 respectively press the first side scrim portion 324 and the second side scrim portion 326 toward the first and second side surfaces of the seating block 250, and the side scrim portions 324 and 326 are held and fixed in a state of being sandwiched between the holding portions 234 and 244 and the side surfaces of the seating block 250, respectively.

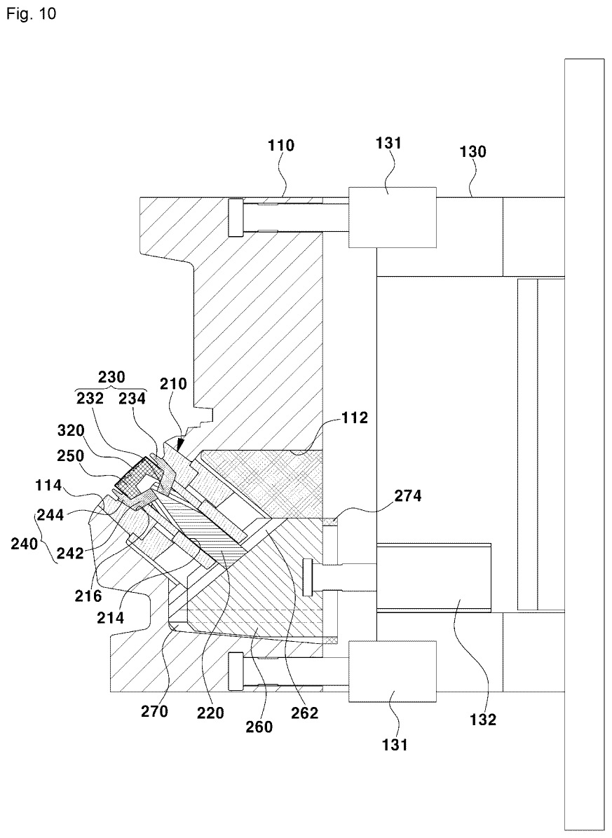

As shown in FIG. 10, the first mold 110 is moved rearwards toward the mold plate 130 by the first actuator 131 so as to be adjacent to the mold plate 130. In this case, the upper portion of the base block 210 is located at the upper end of the fixing module mounting portion 114 in a state of being adjacent to the outer surfaces of the holding portion 234 and 244 of the scrim fixing blocks 230 and 240, and the upper end of the fixing module mounting portion 114 is sealed.

Next, the second mold 120 is moved toward the first mold 110, and as shown in FIG. 11, the first mold 110 is combined with the second mold 120, thereby forming the cavity C between the first mold 110 and the second mold 120. The molding resin for the crash pad is injected into the cavity C. While the molding resin is cured over time, the molding resin is combined with the insert scrim 320 and is completely cured to form a crash pad upper panel 310.

The second mold 120 is separated from the first mold 110 so as to open the molding device 100, and the crash pad upper panel 310 formed to be integrated with the insert scrim 320 is demolded.

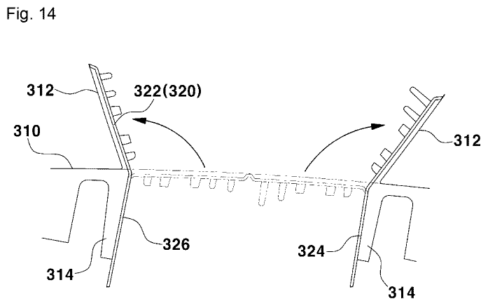

In some implementations, as shown in FIGS. 13 and 14, the crash pad 300 can be configured to include the crash pad upper panel 310 manufactured as described above, an airbag door portion 312 formed to be integrated with the crash pad upper panel 310, and the insert scrim 320 attached to the airbag door portion 312. In some examples, the crash pad 300 can include a crash pad lower panel coupled to the crash pad upper panel 310.

A plurality of reinforcing ribs 314 is formed to protrude from the bottom surface of the crash pad upper panel 310. The reinforcing ribs 314 are formed to be adjacent to the edge of the airbag door portion 312. The reinforcing ribs 314 can be arranged in the circumferential direction of the airbag door portion 312.

The center scrim portion 322 of the insert scrim 320 is attached to the bottom surface of the airbag door portion 312, and the side scrim portions 324 and 326 are attached to the respective reinforcing ribs 314. The side scrim portions 324 and 326 respectively extend from the opposite edges of the center scrim portion 322 toward the opposite sides of the respective airbag door portions 312. In some examples, each of the side scrim portions 324 and 326 extends in a curved shape.

Hereinafter, the preforming device 400 configured to preform the insert scrim 320 will be described with reference to FIGS. 15 and 16.

As shown in FIG. 15, the preforming device 400 includes a jig 410 configured for a scrim material 450 having a flat plate structure to be seated and stacked thereon, a center pressing plate 420 configured to fix the scrim material 450 seated on the jig 410, and a pair of corner pressing plates 430 configured to bend the opposite ends of the scrim material 450.

The jig 410 includes an upper surface on which the scrim material 450 is loaded, and side surfaces each formed to be tapered downwards.

As shown in FIG. 16, when the scrim material 450 is loaded and stacked on the upper surface of the jig 410, the center pressing plate 420 is moved downwards toward the upper surface of the jig 410 so as to press the central portion of the scrim material 450 seated on the upper surface of the jig 410, thereby preventing movement of the scrim material 450.

In a state in which the center pressing plate 420 presses the scrim material 450 toward the upper portion of the jig 410, the corner pressing plates 430 are respectively moved in the diagonal direction toward corner portions on opposite sides of the jig 410. In some examples, each of the corner pressing plates 430 diagonally approaches the jig 410 with a predetermined inclination relative to the movement direction of the center pressing plate 420.

The corner pressing plates 430 press and bend respective predetermined portions of the scrim material 450 seated on the jig 410 from the respective corner portions of the jig 410. In this case, the opposite ends of the scrim material 450 are respectively bent downwards toward the side surfaces of the jig 410.

In a state in which the corner pressing plates 430 respectively press the predetermined portions of the scrim material 450, a pair of side pressing plates 440 is moved toward the opposite side surfaces of the jig 410. The side pressing plates 440 press the opposite ends of the scrim material 450. In this manner, the opposite ends of the scrim material are respectively in close contact with the side surfaces of the jig 410.

In some implementations, the side pressing plates 440 can continuously press the respective opposite ends of the scrim material 450 against the respective side surfaces of the jig 410 until the robot 500 approaches the completely preformed scrim material (that is, the insert scrim) so as to move the scrim material to the molding device 100.

The preforming device 400 configured as described above can correct the spring-back amount of the scrim material 450 by forming the side surfaces of the jig 410 to be tapered downwards at a predetermined inclination. In some examples, spring-back of the scrim material occurs after preformation of the scrim material.

In addition, as shown in FIG. 15, the opposite corner portions of the jig 410 respectively have protrusions 412 formed to protrude upwards. The protrusions 412 respectively extend along the corner portions of the jig 410.

The corner pressing plates 430 respectively have grooves 432 formed to be recessed therein and configured for the protrusions 412 to be respectively inserted thereinto. When the corner pressing plates 430 are moved toward the opposite corner portions of the jig 410, the protrusions 412 of the jig 410 are inserted into the respective grooves 432. Through this structural configuration, formation performance of the preforming device 400 for the scrim material 450 can be improved.

Through the preforming device 400 configured as described above, the insert scrim 320 is preformed into a plate-shaped structure in which the opposite ends (that is, the side scrim portions) are bent in the same direction.

The insert scrim 320 is preformed to have a curved C-shaped cross-sectional structure. Specifically, the insert scrim 320 is preformed to have a rectangular cross-sectional structure with one side open. In addition, the insert scrim 320 can be used as a kind of reinforcing material for reinforcement of the airbag door portion 312.

In some implementations, a crash pad including an insert scrim is molded in a single molding device, thereby having an effect of shortening the manufacturing time of the crash pad and reducing manufacturing costs thereof.

In some implementations, when a molding resin for the crash pad is injected into a cavity of the molding device, a scrim fixing module fixedly holds the insert scrim so as to prevent movement of the insert scrim, thereby having an effect of accurately positioning the insert scrim at the molding position of an airbag door portion in the molding device. As a result, marketability of the crash pad can be secured.

In some implementations, since the insert scrim is preformed to have a curved structure, bonding strength between a crash pad upper panel and the insert scrim can be increased, thereby having an effect of preventing, when the airbag door portion is opened, the insert scrim from being separated from the crash pad upper panel.

The effects of the present disclosure are not limited to the above-mentioned effects, and other effects not mentioned herein will be clearly understood by those skilled in the art from the detailed description of the implementations.

The implementations of the present disclosure have been described in detail above, and the terms or words used in this specification and claims shall not be construed as being limited to typical or dictionary meanings. In addition, since the implementations described in this specification and the configurations shown in the drawings are only implementations of the present disclosure, the scope of the present disclosure is not limited to the above-described implementations. Various modifications and improvements made by those skilled in the art using the basic concept of the present disclosure defined in the following claims also fall within the scope of the present disclosure.

What is claimed is:

1. A manufacturing device for a vehicle crash pad, the manufacturing device comprising:
a scrim fixing module configured to hold opposite bent ends of an insert scrim of the vehicle crash pad;
a first mold comprising:
a fixing module mounting portion that accommodates the scrim fixing module therein, and
a cam block disposed in the first mold and configured to operate the scrim fixing module;
a mold plate comprising:
a first actuator figured to operate the cam block, and
a second actuator configured to operate the first mold; and
a second mold configured to join with the first mold and to define a cavity between the first mold and the second mold based on joining with the first mold, the cavity being configured to receive a molding resin for the vehicle crash pad.

2. The manufacturing device of claim 1, wherein the cavity is configured to accommodate the insert scrim seated on the scrim fixing module.

3. The manufacturing device of claim 2, wherein the first mold further comprises a cam block mounting portion located adjacent to and fluidly connected with the fixing module mounting portion,
wherein the cam block is disposed at the cam block mounting portion and configured to linearly move relative to the cam block mounting portion along a movement direction, and
wherein the fixing module mounting portion extends obliquely relative to the movement direction of the cam block.

4. The manufacturing device of claim 3, wherein the cam block mounting portion comprises a pair of support blocks, and the cam block is slidably disposed between the pair of support blocks.

5. The manufacturing device of claim 4, wherein the scrim fixing module comprises:
a base block having a lower portion supported by the pair of support blocks;
a center core coupled to an inner side of the base block and configured to linearly move in the base block, the center core being connected to the cam block and configured to linearly move in the base block based on a linear movement of the cam block;
a pair of scrim fixing blocks disposed at an upper portion of the base block, each of the pair of scrim fixing blocks being configured to move to an outer side of the base block and to return to the inner side of the base block based on a linear movement of the center core; and
a seating block having (i) an upper surface configured to support the insert scrim thereon and (ii) a lower surface disposed on the pair of scrim fixing blocks.

6. The manufacturing device of claim 5, wherein the center core comprises a first core rail and a second core rail that are disposed at an upper portion of the center core, and
wherein the pair of scrim fixing blocks are configured to slidably move along the first core rail and the second core rail.

7. The manufacturing device of claim 6, wherein the first core rail and the second core rail extend obliquely relative to a movement direction of the center core, and
wherein a first end of the first core rail and a first end of the second core rail extend toward each other.

8. The manufacturing device of claim 7, wherein the pair of scrim fixing blocks comprise a first scrim fixing block comprising:
a first linkage portion configured to slidably move along the first core rail; and
a first holding portion formed to be integrated with the first linkage portion, the first holding portion being configured to, based on the first linkage portion moving to the first end of the first core rail, hold a first end of the insert scrim supported on the seating block.

9. The manufacturing device of claim 8, wherein the pair of scrim fixing blocks comprise a second scrim fixing block including:
a second linkage portion configured to slidably move along the second core rail; and
a second holding portion that extends from the second linkage portion and is configured to, based on the second linkage portion moving to the first end of the second core rail, hold a second end of the insert scrim supported on the seating block.

10. The manufacturing device of claim 5, wherein the cam block comprises a cam rail that is obliquely disposed at an upper portion of the cam block, and
wherein the center core comprises a core rib that is disposed at a lower portion of the center core and configured to slidably move along the cam rail.

11. The manufacturing device of claim 5, wherein the base block comprises a base rib disposed at a lower portion of the base block, and
wherein the pair of support blocks comprise a support rail that is disposed at an upper portion thereof and configured to guide the base rib to slidably move along the support rail.

12. The manufacturing device of claim 5, wherein the first actuator is configured to:
maintain the cam block at a position while the first mold moves in a first direction away from the mold plate, and
linearly move the cam block away from the mold plate based on completion of a movement of the first mold in the first direction.

13. The manufacturing device of claim 12, wherein the pair of scrim fixing blocks are configured to move toward the outer side of the base block based on the cam block moving away from the mold plate by the first actuator, and
wherein the seating block and each of the pair of scrim fixing blocks are configured to define a gap between a side surface of the seating block and a side surface of one of the pair of scrim fixing blocks, each of the gaps being configured to receive one of opposite ends of the insert scrim.

14. The manufacturing device of claim 13, wherein the first actuator is configured to move the cam block toward the mold plate based on the opposite ends of the insert scrim being inserted into the gaps, respectively, and
wherein the pair of scrim fixing blocks are configured to press the opposite ends of the insert scrim toward side surfaces of the seating block.

15. The manufacturing device of claim 1, further comprising a preforming device configured to, before the insert scrim is provided to the scrim fixing module, form the insert scrim into a plate-shaped structure having the opposite ends that are bent, and
wherein the preforming device comprises:
a jig configured to support a scrim material having a flat plate structure,
a center pressing plate configured to move toward an upper surface of the jig and to press the scrim material on the upper surface of the jig to restrict the scrim material from moving,
a pair of corner pressing plates configured to move toward opposite corner portions of the jig and to bend the opposite ends of the scrim material on the jig, and
a pair of side pressing plates configured to press the opposite ends of the scrim material that are respectively bent toward opposite side surfaces of the jig, the pair of side pressing plates being configured to bring the opposite ends of the scrim material into contact with the opposite side surfaces of the jig.

16. The manufacturing device of claim 15, wherein the opposite side surfaces of the jig are tapered toward each other.

17. The manufacturing device of claim 15, wherein the jig comprises protrusions that are respectively disposed at the opposite corner portions of the jig, each of the protrusions protruding toward one of the pair of corner pressing plates.

18. A vehicle crash pad comprising:
a crash pad upper panel comprising an airbag door portion; and
an insert scrim attached to the airbag door portion,
wherein the insert scrim comprises:
a center scrim portion attached to a lower surface of the airbag door portion, and
a pair of side scrim portions that are respectively bent downward from opposite edges of the center scrim portion.

19. The vehicle crash pad of claim 18, wherein the crash pad upper panel further comprises a plurality of reinforcing ribs that are respectively located adjacent to edges of the airbag door portion, the plurality of reinforcing ribs protruding downward from a lower surface of the crash pad upper panel, and
wherein each of the pair of side scrim portions is coupled to one of the plurality of reinforcing ribs.
